(19) United States
(12) Patent Application Publication
(10) Pub. No.: US 2014/0180599 A1
(43) Pub. Date: Jun. 26, 2014

(54) METHODS AND APPARATUS FOR ANALYZING GENETIC INFORMATION

(71) Applicant: Samsung Electronics Co., Ltd., Suwon-si (KR)

(72) Inventors: Eun-jin LEE, Seoul (KR); Tae-jin AHN, Seoul (KR)

(73) Assignee: Samsung Electronics Co., Ltd., Suwon-si (KR)

(21) Appl. No.: 14/100,655

(22) Filed: Dec. 9, 2013

(30) Foreign Application Priority Data
Dec. 20, 2012 (KR) 10-2012-0149755

(51) Int. Cl. G06F 19/22

(52) U.S. Cl. CPC G06F 19/22
USPC 702/19

(57) ABSTRACT

Provided are a method and apparatus for analyzing genetic information to acquire expression data of a subject with respect to gene expression patterns of genes included in a gene network and determine a genetic abnormality of the gene network included in the expression data of the subject by using a representative expression pattern estimated from a group of normal people.

### CROSS-REFERENCE TO RELATED APPLICATIONS

This application claims the benefit of Korean Patent Application No. 10-2012-0149755, filed on Dec. 20, 2012, in the Korean Intellectual Property Office, the disclosure of which is incorporated herein in its entirety by reference.

### BACKGROUND

1. Field

The present disclosure relates to methods and apparatuses for analyzing genetic information regarding a subject to diagnose a disease, such as cancer or a tumor.

2. Description of the Related Art

A genome indicates all the genetic information for a living organism. Various techniques for sequencing the genome of an individual, such as a Deoxyribonucleic Acid (DNA)-chip and next generation sequencing technique, a next-next generation sequencing technique, and so forth, have been developed. The analysis of genetic information, such as a nucleic acid sequence, protein, and so forth, is widely used to find a gene expressing a disease, such as diabetes, cancer, or the like, or perceive a correlation between a genetic variation and expression characteristics of an individual. In particular, genetic information collected from individuals is very useful to identify or determine individual genetic features related to different symptoms or progress of a disease. Thus, such genetic information is important data for perceiving current and future disease-related information to help prevent a disease or to select an optimal treatment method at an initial stage of a disease. Techniques for accurately analyzing individual genetic information by using genome detection devices, such as a DNA chip, a microarray, and so forth, for detecting a single nucleotide polymorphism (SNP), a copy number variation (CNV), and so forth as genetic information of a living organism are well known.

Recently, the development of genome research has caused a functional correlation between genes included in a genome to be gradually revealed, and accordingly, gene network analysis between genes has received attention. This may be because almost all physiological phenomena occurring in a certain living organism are achieved not by one gene but by mutual reactions between several genes. A gene network is represented as a network in which genes are complicatedly connected to each other and may be acquired from a database (DB) that is well known to one of ordinary skill in the art. However, since the development of gene analysis technology causes a steady discovery and update of a new gene network, it is desirable to provide genetic information analysis methods and apparatus that are not limited to a gene network that may be acquired from well-known DBs.

### SUMMARY

Provided are a method and apparatus for analyzing genetic information regarding a subject.

Provided is a non-transitory computer-readable storage medium having stored therein program instructions, which when executed by one or more processors (e.g., in a computer), perform the method.

Additional aspects will be set forth in part in the description which follows and, in part, will be apparent from the description, or may be learned by practice of the presented embodiments.

According to an aspect of the present disclosure, a method of analyzing genetic information includes the steps, implemented in a processor, of: receiving or acquiring first expression data of a group of normal people and second expression data of a subject with respect to gene expression patterns of genes included in a gene network; calculating an estimate of a representative expression pattern summarizing a distribution of the gene expression patterns of individuals belonging to the group of normal people, which are included in the first expression data; analyzing a distribution of a similarity of each of gene expression patterns of the individuals and the subject with respect to the representative expression pattern; and determining a genetic abnormality of the gene network of the subject, which is included in the acquired second expression data, based on the analyzed distribution of the similarity.

According to another aspect of the present disclosure, provided is a non-transitory computer-readable storage medium having stored therein program instructions, which when executed by one or more processors (e.g., in a computer or computer system), perform the method of analyzing genetic information.

According to another aspect of the present disclosure, an apparatus for analyzing genetic information includes: a data acquisition unit that receives or acquires first expression data of a group of normal people and second expression data of a subject with respect to gene expression patterns of genes included in a gene network; an estimating unit that calculates an estimate of a representative expression pattern summarizing a distribution of the gene expression patterns of individuals belonging to the group of normal people, which are included in the acquired first expression data; an analyzing unit that analyzes a distribution of a similarity of each of gene expression patterns of the individuals and the subject with respect to the representative expression pattern; and a determining unit that identifies or determines a genetic abnormality of the gene network of the subject, which is included in the acquired second expression data, based on the analyzed distribution of the similarity.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a genetic information analysis system according to an embodiment of the present disclosure;

FIGS. 2A and 2B are diagrams for describing a gene network of a subject having cancer, which may be accurately analyzed by an apparatus for analyzing genetic information, according to an embodiment of the present disclosure;

FIGS. 3A to 3D are diagrams for describing an existing method of analyzing a gene network and problems thereof;

FIG. 4 is a block diagram of an apparatus for analyzing genetic information, according to an embodiment of the present disclosure;

FIG. 5 is a graph for describing gene expression patterns included in first expression data and a gene expression pattern included in second expression data, which are acquired by a data acquisition unit, and a representative expression pattern estimated by an estimating unit, according to an embodiment of the present disclosure;

FIG. 6 is a graph illustrating a statistical model generated by a model generator, according to an embodiment of the present disclosure;

FIG. 7 is a diagram for describing a method of determining a genetic abnormality of a gene network (or a gene pathway) in a determining unit, according to an embodiment of the present disclosure; and

FIG. 8 is a flowchart illustrating a method of analyzing genetic information, according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

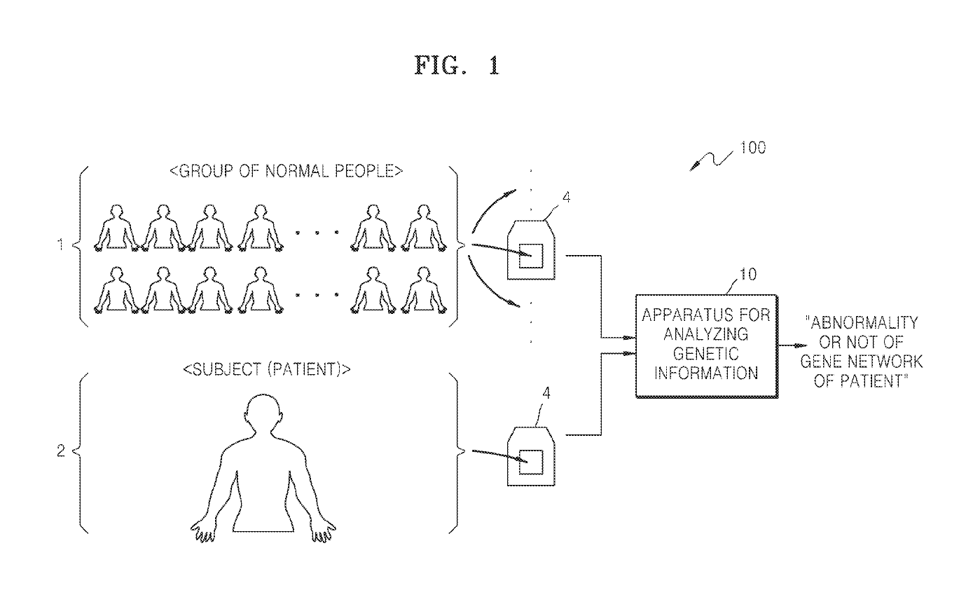

FIG. 1 illustrates a genetic information analysis system 100 according to an embodiment of the present disclosure. Referring to FIG. 1, the genetic information analysis system 100 may include an apparatus 10 for analyzing genetic information and a microarray 4 for analyzing genetic information of a group 1 of normal people and a subject (patient) 2.

Although not shown in FIG. 1, it will be understood by one of ordinary skill in the art that the genetic information analysis system 100 may further include image analyzing devices, such as a high content cell imaging device, a high content screening device, and a high throughput screening device, for detecting gene expression patterns or gene expression levels from the group 1 of normal people and the subject 2, and a polymerase chain reaction (PCR) device or the like may be used instead of the microarray 4.

That is, although the genetic information analysis system 100 shown in FIG. 1 includes only components related to the current embodiment to prevent obscuring the features of the current embodiment, other general-use components may be further included in addition or alternatively to the components shown in FIG. 1.

A nucleic acid, such as a Deoxyribonucleic Acid (DNA), of an individual corresponds to a genetic material, i.e., a gene, including genetic information of the individual. Such a nucleic acid sequence includes information regarding cells, tissue, and so forth of an individual. Thus, much research into information regarding a perfect nucleic acid sequence of an individual has been conducted in many fields, including for the understanding of life phenomena, the development of new medicines, the diagnosis and prevention of diseases, human inheritance research, and so forth.

Recently, the development of genome research has caused a functional correlation between genes included in a genome to be gradually revealed, and accordingly, gene network analysis between genes has received attention. This may be because almost all physiological phenomena occurring in a certain living organism are achieved not by one gene but by mutual reactions between several genes.

A gene network is represented as a network in which genes are complicatedly connected to each other and may be acquired from a database (DB) that is well known to one of ordinary skill in the art. However, since the development of gene analysis technology causes a steady discovery and update of a new gene network, the gene network described in the current embodiment is not limited to a gene network acquired from the well-known DB.

In the genetic information analysis system 100, the apparatus 10 is used to analyze genetic information related to a gene network of the subject 2 and accurately diagnose whether the subject 2 has a disease, such as cancer, a tumor, or the like.

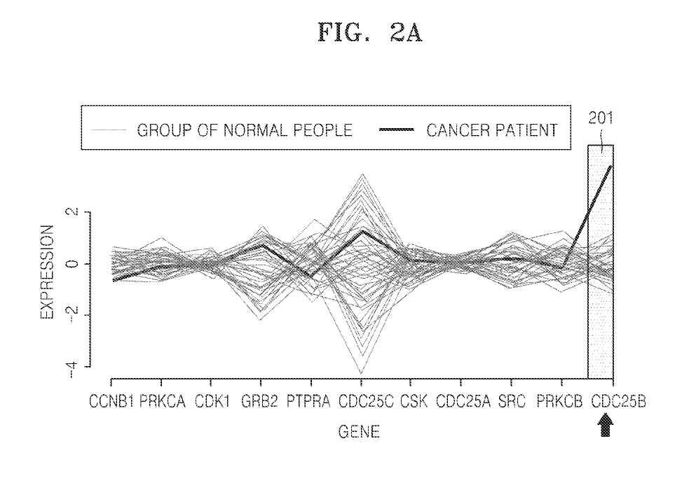

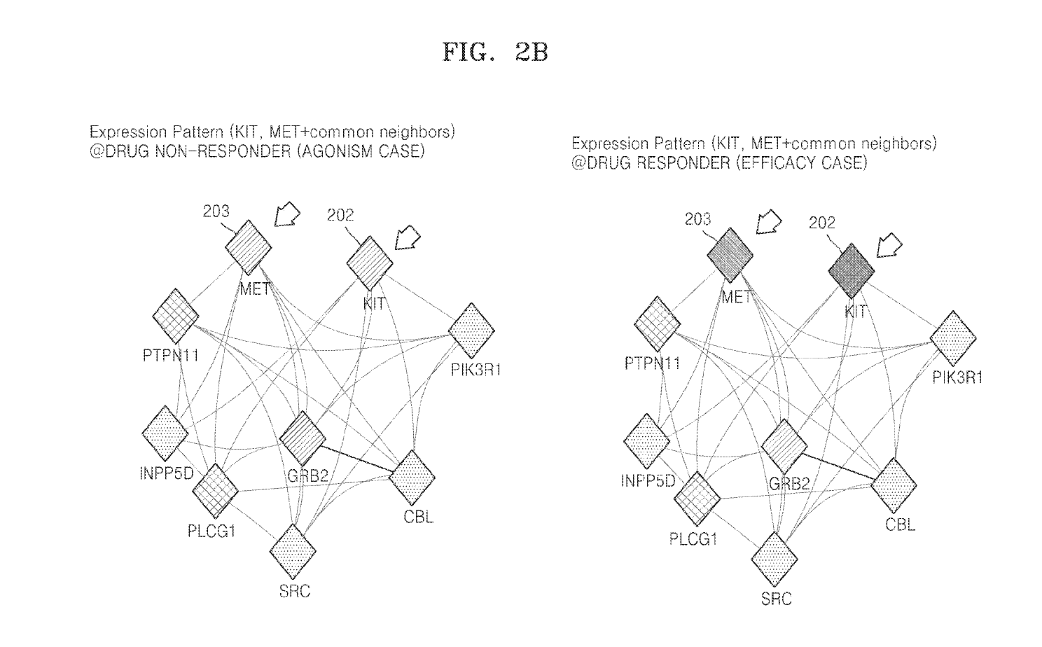

FIGS. 2A and 2B are diagrams for describing the gene network of the subject 2 having cancer, which may be accurately analyzed by the apparatus 10 for analyzing genetic information, according to an embodiment of the present disclosure.

Referring to FIG. 2A, in the analysis result of a specific gene network of the subject 2 having cancer, even when there is a difference in a gene expression pattern of only one gene (e.g., a CDC25B gene 201) in comparison with gene expression patterns of the group 1 of normal people, the apparatus 10 may accurately analyze this difference to thereby diagnose cancer.

FIG. 2B schematically shows a certain gene network and genes included therein. In FIG. 2B, when a difference between a drug non-responder (an agonism case) and a drug responder (an efficacy case) is observed, a genetic abnormality exists only in a KIT gene 202 and an MET gene 203 from among all the genes included in the gene network. That is, similarly to the description of FIG. 2A, even when only a small number of partial genes (the KIT gene 202 and the MET gene 203) differ from those in a normal gene expression pattern, the apparatus 10 may accurately analyze this difference to thereby diagnose cancer.

However, according to the existing methods and apparatuses, even though a gene network of the subject 2 (e.g., a cancer patient) having an abnormality in a small number of genes 201 or 202 and 203, as shown in FIG. 2A or 2B, is analyzed, it cannot be accurately analyzed whether a genetic abnormality exists in the entire gene network. The reason for this is described below.

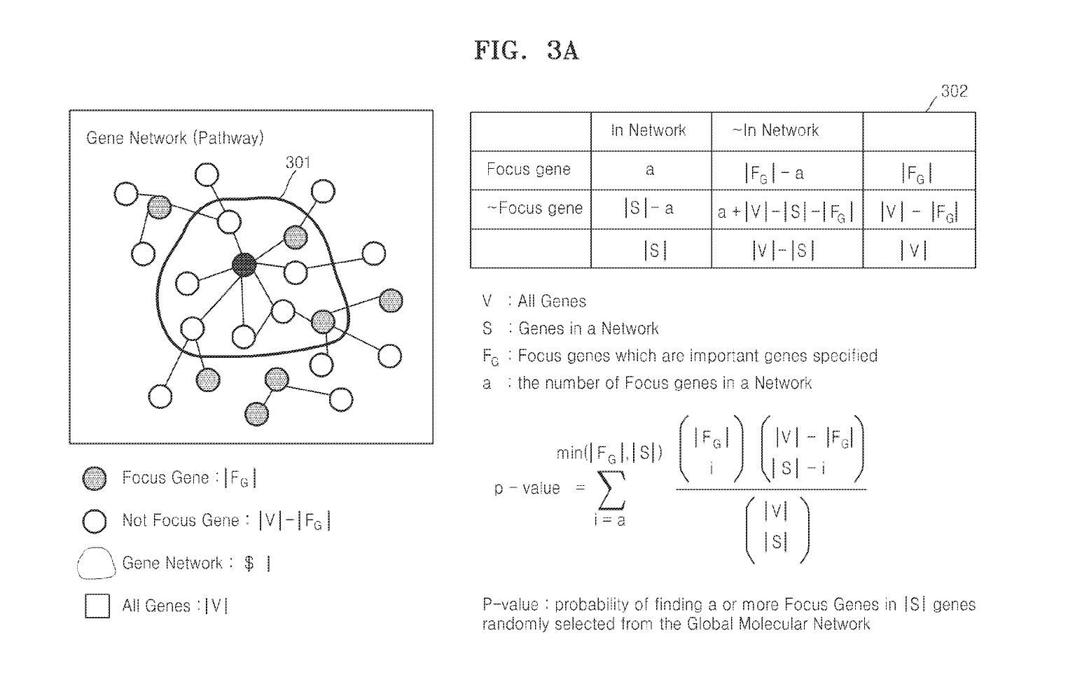

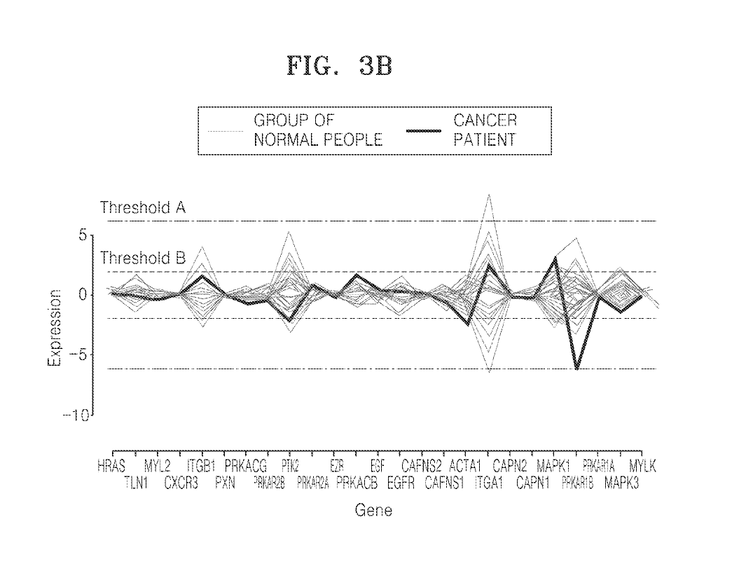

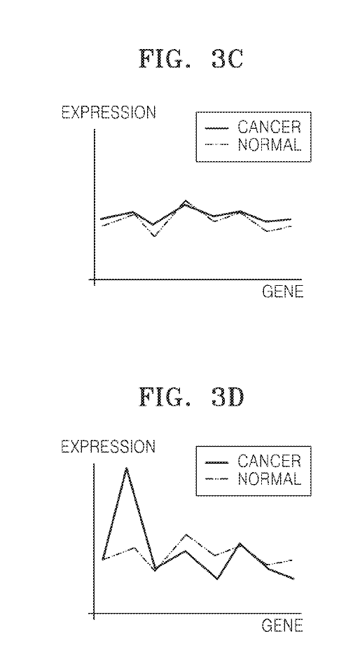

FIGS. 3A to 3D are diagrams for describing an existing method of analyzing a gene network and problems thereof.

Referring to FIG. 3A, according to an existing method, a genetic abnormality of a gene network 301 is determined using a Fisher's exact test. According to the Fisher's exact test, gene expression levels of all the genes V and information regarding the gene network 301 are analyzed. From among all the genes V, genes having a gene expression level greater than a certain threshold are defined as focus genes F_{G}, and genes having a gene expression level less than the certain threshold are defined as non-focus genes. Accordingly, the Fisher's exact test has a problem in that gene expression levels having continuous values are divided into two groups by the certain threshold.

A division table 302 is generated based on genes S in the gene network 301 and information regarding the focus genes F_{G} from among all the genes V. The Fisher's exact test assumes a hypergeometric distribution to calculate an observation probability of the number a of focus genes F_{G} in the gene network 301. Thereafter, the Fisher's exact test calculates a statistical probability value p-value by using values in the division table 302. Finally, the Fisher's exact test determines based on the calculated statistical probability value p-value whether the gene network 301 of an individual is normal.

As described above, the Fisher's exact test has a problem in that information on the gene network 301 is lost by dividing gene expression levels having continuous values into two groups by the certain threshold. In particular, as shown in FIG. 3B, since genes may be focus genes or non-focus genes according to which value is set as a threshold, there is a problem that an analysis result of the Fisher's exact test may vary according to the threshold.

In addition, when there is a slight difference in all gene expression patterns of the gene network 301, as shown in FIG. 30, or when there is a great difference in only a small number of gene expression patterns of the gene network 301, as shown in FIG. 3D, there is a problem that a genetic abnormality of the gene network 301 cannot be sensitively analyzed using the Fisher's exact test. In conclusion, due to the above-described problems, the reliability and accuracy of the analysis using the Fisher's exact test in terms of whether the gene network 301 has a genetic abnormality is definitely low.

Referring back to FIG. 1, the apparatus 10 of the genetic information analysis system 100 accurately analyzes whether a gene network has a genetic abnormality, by quantitizing differences between the gene expression patterns of the group 1 of normal people and the gene expression pattern of the subject (patient) 2. That is, unlike the Fisher's exact test, the apparatus 10 may use information included in gene expression levels of the gene network as it is, and without losing the information, by not dividing gene expression levels having continuous values into two groups (focus genes and non-focus genes), and thus, the apparatus 10 may accurately analyze the meaning included in the gene network (e.g., whether the gene network is related to a disease, such as cancer or the like).

Operations and functions of the apparatus 10 according to the current embodiment will now be described in more detail.

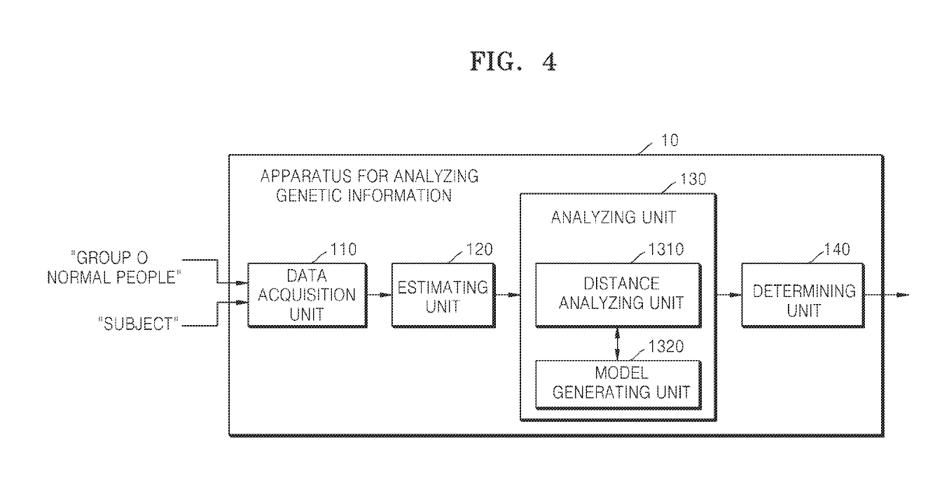

FIG. 4 is a block diagram of the apparatus 10 for analyzing genetic information, according to an embodiment of the present disclosure. Referring to FIG. 4, the apparatus 10 may include a data acquisition unit 110, an estimating unit 120, an analyzing unit 130, and a determining unit 140. The analyzing unit 130 may include a distance analyzing unit 1310 and a model generator 1320.

The apparatus 10 may be implemented by generally used processors. That is, the apparatus 10 may be implemented by an array of a plurality of logic gates or by a combination of one or more general-use microprocessors and a memory in which programs executable by the microprocessor(s) are stored. In addition, the apparatus 10 may be implemented by a module form of application programs. Further, it will be understood by one of ordinary skill in the art that the apparatus 10 may be implemented by another form of hardware for realizing operations to be described in the current embodiment.

Although the apparatus 10 shown in FIG. 4 includes only components related to the current embodiment to prevent obscuring the features of the current embodiment, other general-use components may be further included in addition or alternatively to the components shown in FIG. 4.

The data acquisition unit 110 acquires first expression data of the group 1 of normal people and second expression data of the subject (patient) 2 with respect to gene expression patterns of genes included in a certain gene network.

The first and second expression data with respect to the gene expression patterns, which are acquired by the data acquisition unit 110, may correspond to image data analyzed by image analyzing devices, such as a high content cell imaging device, a high content screening device, and a high throughput screening device, after performing a hybridization reaction of biological samples gathered from the group 1 of normal people and the subject (patient) 2 in the microarray 4. Alternatively, the first and second expression data may correspond to statistical data obtained by digitizing gene expression patterns analyzed from the image data.

Since a detailed process of acquiring expression data from biological samples by using the microarray 4 and the image analyzing devices would be apparent to one of ordinary skill in the art, a detailed description thereof is omitted.

The estimating unit 120 receives data from the data acquisition unit 10 and estimates a representative expression pattern summarizing a distribution of gene expression patterns of individuals belonging to the group 1 of normal people, which are included in the first expression data acquired by the data acquisition unit 110.

In more detail, the estimating unit 120 estimates a representative expression pattern of each gene included in the first expression data by calculating a representative value (e.g., a centroid) for each of the genes based on the gene expression patterns using a statistical data processing method. Such values might include a mean value, a weighted mean value, a median value, or the like of the gene expression patterns.

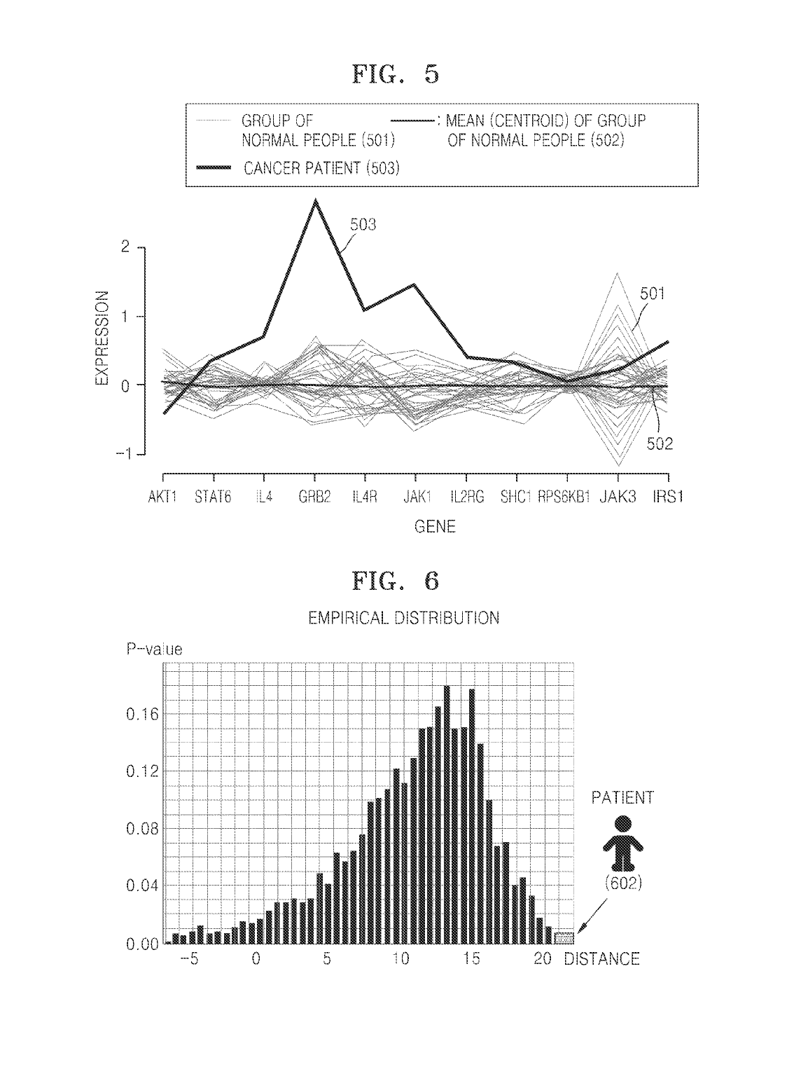

FIG. 5 is a graph illustrating gene expression patterns 501 included in the first expression data and a gene expression pattern 503 included in the second expression data, which are acquired by the data acquisition unit 110, and a representative expression pattern 502 estimated by the estimating unit 120, according to an embodiment of the present disclosure. In FIG. 5, it is assumed that AKT1, STATE, IL4, GRB2, IL4R, JAK1, IL2RG, SHC1, RPS6KB1, JAK3, and IRS1 denote genes included in a gene network.

As described above, the gene expression patterns 501 included in the first expression data acquired by the data acquisition unit 110 are variously distributed on a gene basis with respect to individuals belonging to the group 1 of normal people. In addition, although the gene expression pattern 503 included in the second expression data acquired by the data acquisition unit 110 is also distributed on a gene basis, the gene expression pattern 503 has a somewhat different distribution from that of the group 1 of normal people. In particular, in FIG. 5, the gene expression pattern 503 for the GRB2 and JAK1 genes of the subject 2 is somewhat different from that of the group 1 of normal people.

The estimating unit 120 estimates the representative expression pattern 502 summarizing a distribution of the gene expression patterns 501 included in the first expression data for each gene. For example, the estimating unit 120 may estimate the representative expression pattern 502 with a representative value (e.g., a centroid) based on a mean value by using Equation 1.

$$\begin{matrix}[ Centroid ] & \\ μ = {( {μ}_{N 1} , {μ}_{N 2} , {μ}_{N 3} , … , {μ}_{Ng} )}^{T} \\ where {μ}_{Nj} = \frac{{\sum }_{i = 1}^{n} {x}_{Nij}}{n} \\ i = 1 , … , n ( Individual Normal Sample ) \\ j = 1 , … , n ( Individual Gene In Gene Network ) & ( 1 )\end{matrix}$$

However, as described above, it will be understood by one of ordinary skill in the art that the representative expression pattern 502 may be estimated by calculating a representative value (e.g., a centroid) based on a weighted mean value, a median value, or the like, besides a mean value.

Referring back to FIG. 4, the analyzing unit 130 analyzes a distribution of a similarity of each of the gene expression patterns 501 and 503 of the individuals belonging to the group 1 of normal people and the subject 2 with respect to the estimated representative expression pattern 502.

In particular, the analyzing unit 130 may analyze the distribution of the similarity by using a statistical distance of each of the gene expression patterns 501 and 503 of the individuals belonging to the group 1 of normal people and the subject 2 with respect to the estimated representative expression pattern 502.

Examples of useful statistical distance values include a Mahalanobis distance, a Euclidean distance, a Manhattan distance (a city block distance or a taxicab geometry), a maximum distance, a minimum distance, a correlation coefficient, and so forth. Since examples of determining statistical distance values would be apparent to one of ordinary skill in the art, a detailed description thereof is omitted. In particular, although it is mainly described in the current embodiment that the analyzing unit 130 uses a Mahalanobis distance, it will be understood by one of ordinary skill in the art the current embodiment is not limited thereto.

The distance analyzing unit 1310 of the analyzing unit 130 determines a statistical distance between the representative expression pattern 502 and a gene network of each of the individuals belonging to the group 1 of normal people. When a Mahalanobis distance is used, the distance analyzing unit 1310 calculates Mahalanobis distances between the representative expression pattern 502 and the gene expression patterns 501 included in the first expression data by using covariances (or covariance matrices). In this case, the distance analyzing unit 1310 may calculate Mahalanobis distances for the group 2 of normal people by using Equation 2.

Mahalanobis Distance of ith Normal Sample is

MD_{Ni}=\sqrt{(x_{Nij}−μ_{Nj})^{T} S(x_{Nij}−μ_{Nj})}
x=(x_{Ni1}, x_{Ni2}, X_{Ni3}, . . . , x_{Nig})^{T} (Individual Gene Expression)
μ=(μ_{N1}, μ_{N2}, μ_{N3}, . . . , μ_{Ng})^{T} (Centroid)
S=Covariance Matrix
i=1, . . . , n (Individual Normal Sample)
j=1, . . . , g (Individual Gene In Gene Network)

For the Number of n Normal Samples, Mahalanobis Distances are

MD_{N}={MD_{N1}, MD_{N2}, MD_{N3}, . . . , MD_{Nn}} (2)
n=Number of Normal Sample

In addition, the distance analyzing unit 1310 analyzes a statistical distance between the representative expression pattern 502 and a gene network of the subject 2. In this case, the distance analyzing unit 1310 may calculate a Mahalanobis distance for the subject 2 by using Equation 3.

Mahalanobis Distance of the Cancer Sample is

MD_{C}=\sqrt{(x_{Ch}−μ_{Nj})^{T} S(x_{Cj}−μ_{Nj})} (3)
x=(x_{C1}, x_{C2}, x_{C3}, . . . , x_{Cg})^{T} (Individual Gene Expression)
μ=(μ_{N1}, μ_{N2}, μ_{N3}, . . . , μ_{Ng})^{T} (Centroid)
S=Covariance Matrix
j=1, . . . , g (Individual Gene In Gene Network)

A method of calculating a representative value (e.g., a centroid) or a distance using Equation 1, 2, or 3 has been described. However, the current embodiment is not limited to Equation 1, 2, or 3. That is, it should be appreciated that other forms of equations for deriving a similar result may be used in the current embodiment as would be apparent to one of ordinary skill in the art.

The model generator 1320 of the analyzing unit 130 generates a statistical model indicating a distribution of the statistical distances acquired from the individuals belonging to the group 1 of normal people. The generated statistical model may be generated based on an empirical distribution of the statistical distances acquired from the individuals. However, the model generator 1320 is not limited thereto, and it will be understood by one of ordinary skill in the art that the statistical model may be generated using another statistical distribution methodology.

In certain aspects, the model generator 1320 generates the statistical model based on an empirical distribution obtained by sequentially ranking the statistical distances acquired from the individuals belonging to the group 1 of normal people.

FIG. 6 is an example of a graph illustrating a statistical model 601 generated by the model generator 1320, according to an embodiment of the present disclosure. Referring to FIG. 6, an x-axis indicates a statistical distance acquired from each of the individuals belonging to the group 1 of normal people, and a y-axis indicates a probability distribution of each individual having the value of the x-axis.

For the model generator 1320 to generate the statistical model 601, the distance analyzing unit 1310 may calculate in advance the statistical distances of the group 1 of normal people. However, a process of calculating the statistical distance of the subject 2 in the distance analyzing unit 1310 may be performed before or after the statistical distances of the group 1 of normal people are calculated or before or after the statistical model 601 is generated.

Referring back to FIG. 4, the determining unit 140 determines a genetic abnormality of the gene network of the subject 2, which is included in the second expression data, based on the analyzed distribution of the similarity (statistical distance).

In more detail, the determining unit 140 determines the genetic abnormality by testing a statistical significance level corresponding to a point (602 of FIG. 6) at which the statistical distance for the subject 2 exists by using the statistical model 601 indicating an empirical distribution of the statistical distances for the group 1 of normal people.

In particular, the determining unit 140 may set a predetermined threshold as a criterion for determining a genetic abnormality and determine a degree of genetic abnormality by comparing the statistical significance level for the statistical distance for the subject 2 and the predetermined threshold. Each of the statistical significance level and the predetermined threshold may be a value corresponding to a type of probability, cumulative probability, ranking, quantile, deviation, or the like.

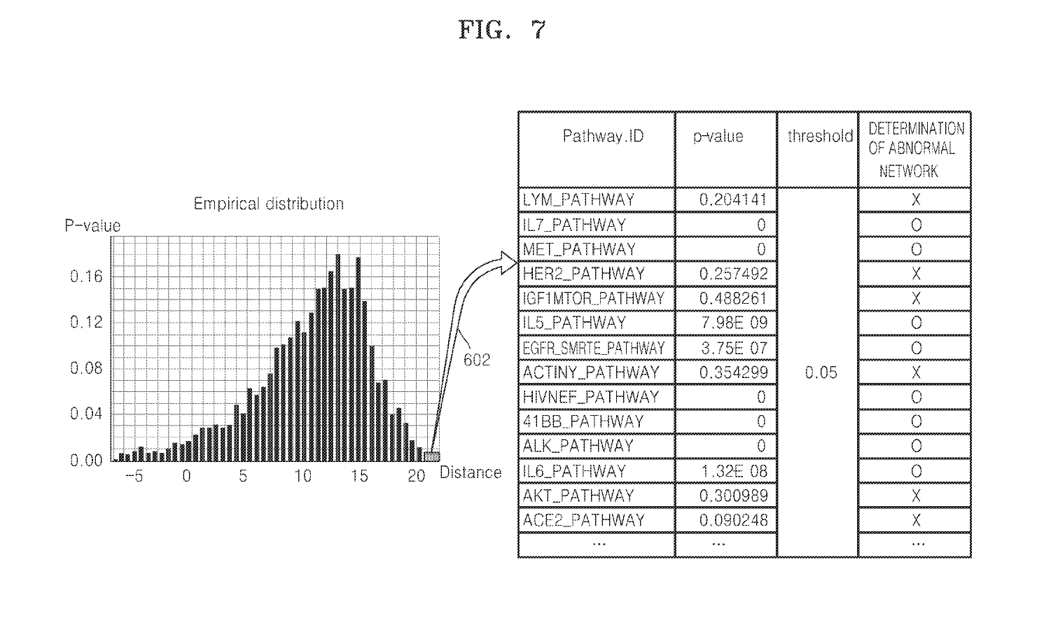

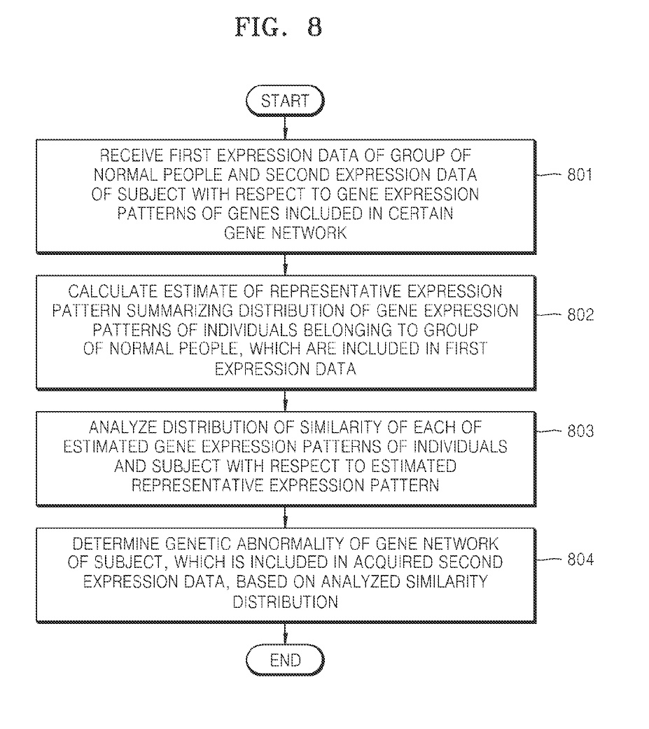

FIG. 7 is a diagram for describing a method of determining a genetic abnormality of a gene network (or a gene pathway) in the determining unit 140, according to an embodiment of the present disclosure.

Referring to FIG. 7, for a gene network LYM_PATHWAY, the determining unit 140 performs a test with 0.204141 as a statistical significance level (p-value) corresponding to the point 602 at which the statistical distance for the subject 2 exists. When the predetermined threshold is set to 0.05, the determining unit 140 determines that there is no genetic abnormality in the gene network LYM_PATHWAY since 0.204141 (p-value)>0.05 (threshold). It will be understood by one of ordinary skill in the art that the predetermined threshold may be changed.

However, for gene networks MET_PATHWAY and IL5_PATHWAY, the determining unit 140 performs a test with 0 and 7.98E-09 as statistical significance levels (p-values) corresponding to the point 602 at which the statistical distance for the subject 2 exists, respectively. Thus, the determining unit 140 determines that genetic abnormality exists in the gene networks MET_PATHWAY and IL5_PATHWAY since 0 (p-value)<0.05 (threshold) and 7.98E-09 (p-value)<0.05 (threshold).

Thus, the determining unit 140 may determine a genetic abnormality of each of the gene networks included in the second expression data for the subject 2. The determining unit 140 may provide the determination result of the genetic result for display on a user interface device (not shown) connected to the apparatus 10 and may provide information on a statistical significance level for a gene network of the subject 2.

Referring back to FIG. 4, according to another embodiment, the apparatus 10 may further include a data transformation unit (not shown) for transforming a dimension of data related to gene expression patterns by applying an algorithm, such as a principal component analysis (PCA) algorithm, an independent component analysis (ICA) algorithm, or the like, to the first expression data and the second expression data acquired by the data acquisition unit 110. In more detail, the data transformation unit transforms gene expression patterns distributed on a gene basis in the first expression data and the second expression data into values corresponding to variables in another dimension. Since a process of transforming certain statistical numeric data, such as the first expression data and the second expression data, into data corresponding to variables in another dimension by using an algorithm, such as the PCA algorithm, the ICA algorithm, or the like, would be apparent to one of ordinary skill in the art, a detailed description thereof is omitted.

According to another embodiment, the estimating unit 120, the analyzing unit 130, and the determining unit 140 perform the processes described above in the same way by using the data transformed from the first expression data and the second expression data by the data transformation unit. In other words, the estimating unit 120, the analyzing unit 130, and the determining unit 140 perform the estimation, analysis, and determination processes described above by using the data transformed by the data transformation unit instead of using the first expression data and the second expression data as they are.

Referring back to FIG. 1, unlike the existing method, since the apparatus 10 uses the gene expression levels having continuous values as they are without dividing them into two groups (focus genes and non-focus genes), the meaning (whether there is genetic abnormality) included in a gene network may be accurately analyzed. Thus, as shown in FIGS. 3C and 3D, even when there is a great difference from normal genes in a small number of genes in a certain gene network or when there is a slight difference from normal genes in a great number of genes in a certain gene network, a genetic abnormality of the certain gene network may be sensitively analyzed.

FIG. 8 is a flowchart illustrating a method of analyzing genetic information, according to an embodiment of the present disclosure. Referring to FIG. 8, the method of analyzing genetic information, according to this embodiment of the present disclosure, includes operations sequentially processed by the genetic information analysis system 100 and the apparatus 10 shown in FIGS. 1 to 4. Thus, although omitted hereinafter, the above description related to FIGS. 1 to 4 is also applied to the method of analyzing genetic information, according to an embodiment of the present disclosure.

In operation 801, the data acquisition unit 110 acquires or receives first expression data of the group 1 of normal people and second expression data of the subject 2 with respect to gene expression patterns of genes included in a gene network.

In operation 802, the estimating unit 120 estimates a representative expression pattern summarizing a distribution of the gene expression patterns 501 of individuals belonging to the group 1 of normal people, which are included in the first expression data.

In operation 803, the analyzing unit 130 analyzes a distribution of a similarity (statistical distance) of each of gene expression patterns of the individuals belonging to the group 1 of normal people and the subject 2 with respect to the estimated representative expression pattern 502.

In operation 804, the determining unit 140 determines a genetic abnormality of the gene network of the subject 2, which is included in the second expression data, based on the analyzed distribution of the similarity (statistical distance).

As described above, according to the one or more of the above embodiments of the present disclosure, by quantitizing differences between gene expression patterns of a group of normal people and a gene expression pattern of one subject (e.g., a cancer patient), a genetic abnormality of a gene network may be accurately analyzed. That is, by not dividing gene expression levels having continuous values into two groups (significant genes and insignificant genes), information included in gene expression levels of the gene network may be analyzed as it is without losing the information, and thus, the meaning included in the gene network (e.g., whether the gene network is related to a disease, such as cancer or the like) may be accurately analyzed. In addition, in a certain gene network, even when a small number of genes are largely different from normal genes or a large number of genes are a little different from normal genes, a genetic abnormality of the gene network may be sensitively analyzed.

The embodiments of the present disclosure may be written as computer programs and may be implemented in general-use digital computers that execute the programs using a computer-readable recording medium. In addition, a structure of the data used in the embodiments of the present disclosure may be written in the computer-readable recording medium in various methods. Examples of the computer-readable recording media include non-transitory storage media, such as magnetic storage media (e.g., ROM, floppy disks, hard disks, etc.) and optical recording media (e.g., CD-ROMs, or DVDs).

In addition, other embodiments of the present disclosure can also be implemented through computer readable code/instructions in/on a medium, e.g., a non-transitory computer-readable recording medium, to control at least one processing element to implement any above described embodiment. The medium can correspond to any medium/media permitting the storage and/or transmission of the computer readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. Thus, the medium may be such a defined and measurable structure including or carrying a signal or information, such as a device carrying a bitstream according to one or more embodiments of the present disclosure. The media may also be a distributed network, so that the computer-readable code is stored/transferred and executed in a distributed fashion. Furthermore, the processing element (e.g., a microprocessor) could include a processor or a computer processor, and processing elements may be distributed and/or included in a single device.

While the present disclosure has been particularly shown and described with reference to exemplary embodiments thereof, it will be understood by one of ordinary skill in the art that various changes in form and details may be made therein without departing from the spirit and scope of the present disclosure as defined by the following claims. The exemplary embodiments should be considered in descriptive sense only and not for purposes of limitation. Therefore, the scope of the present disclosure is defined not by the detailed description of the present disclosure but by the appended claims, and all differences within the scope will be construed as being included in the present disclosure.

What is claimed is:

1. A computer-implemented method of analyzing genetic information, the method comprising the steps, implemented in a processor, of:
receiving first expression data of a group of normal people and second expression data of a subject with respect to gene expression patterns of genes included in a gene network;
calculating an estimate of a representative expression pattern summarizing a distribution of the gene expression patterns of individuals belonging to the group of normal people, which are included in the first expression data;
analyzing a distribution of a similarity of each of the estimated gene expression patterns of the individuals and the subject with respect to the representative expression pattern; and
determining a genetic abnormality of the gene network of the subject, which is included in the acquired second expression data, based on the analyzed distribution of the similarity.

2. The method of claim 1, wherein the analyzing comprises analyzing the distribution of the similarity by using a statistical distance of each of the gene expression patterns of the individuals and the subject with respect to the estimated representative expression pattern.

3. The method of claim 2, wherein the statistical distance includes at least one distance selected from the group consisting of a Mahalanobis distance, a Euclidean distance, a Manhattan distance, a maximum distance, a minimum distance, and a correlation coefficient.

4. The method of claim 2, wherein the analyzing comprises analyzing the distribution of the similarity by calculating Mahalanobis distances between the estimated representative expression pattern and the gene expression patterns included in the first expression data by using covariances.

5. The method of claim 2, wherein the analyzing comprises:
determining statistical distances between the estimated representative expression pattern and the gene network for each of the individuals; and
generating a statistical model indicating a distribution of the statistical distances acquired from each of the individuals.

6. The method of claim 5, wherein the generated statistical model is generated based on an empirical distribution of the statistical distances determined for each of the individuals.

7. The method of claim 5, wherein the analyzing comprises analyzing a statistical distance between the estimated representative expression pattern and the gene network of the subject.

8. The method of claim 1, wherein the calculating an estimate comprises estimating the representative expression pattern for each of the genes included in the acquired first expression data by calculating a representative value or a centroid with respect to each of the genes based on at least one statistical method, wherein the value is selected from the group consisting of a mean value, a weighted mean value, and a median value of the gene expression patterns.

9. The method of claim 1, further comprising transforming the first expression data and the second expression data with respect to the gene expression patterns using an algorithm that reduces or transforms a dimension of the first expression data and the second expression data,
wherein the calculating an estimate, the analyzing, and the determining are performed using the transformed data.

10. The method of claim 1, wherein the determining comprises determining the genetic abnormality by testing a statistical significance level corresponding to a point at which a degree of the similarity analyzed for the subject exists in a distribution of degrees of the similarity analyzed for the group of normal people.

11. The method of claim 10, wherein the determining comprises:
testing the statistical significance level with respect to a statistical distance acquired from the subject by using a statistical model indicating a distribution of statistical distances acquired from the individuals; and
determining the genetic abnormality by comparing the statistical significance level with a predetermined threshold.

12. The method of claim 11, wherein each of the statistical significance level and the predetermined threshold includes a value of a type of at least one value type selected from the group consisting of probability, cumulative probability, ranking, quantile, and deviation.

13. A non-transitory computer-readable storage medium having stored therein program instructions, which when executed by a processor, cause the processor to:
receive first expression data of a group of normal people and second expression data of a subject with respect to gene expression patterns of genes included in a gene network;
calculate an estimate of a representative expression pattern summarizing a distribution of the gene expression patterns of individuals belonging to the group of normal people, which are included in the acquired first expression data;
analyze a distribution of a similarity of each of the estimated gene expression patterns of the individuals and the subject with respect to the representative expression pattern; and
determine a genetic abnormality of the gene network of the subject, which is included in the second expression data, based on the analyzed distribution of the similarity.

14. An apparatus for analyzing genetic information, the apparatus comprising:
a unit that receives or acquires first expression data of a group of normal people and second expression data of a subject with respect to gene expression patterns of genes included in a gene network;
an estimating unit that calculates an estimate of a representative expression pattern summarizing a distribution of the gene expression patterns of individuals belonging to the group of normal people, which are included in the first expression data;
an analyzing unit that analyzes a distribution of a similarity of each of the gene expression patterns of the individuals and the subject with respect to the representative expression pattern; and
a determining unit that determines a genetic abnormality of the gene network of the subject, which is included in the acquired second expression data, based on the analyzed distribution of the similarity.

15. The apparatus of claim 14, wherein the analyzing unit analyzes the distribution of the similarity by using a statistical distance of each of the gene expression patterns of the individuals and the subject with respect to the estimated representative expression pattern.

16. The apparatus of claim 15, wherein the analyzing unit analyzes the distribution of the similarity by calculating Mahalanobis distances between the estimated representative expression pattern and the gene expression patterns included in the first expression data by using covariances.

17. The apparatus of claim 15, wherein the analyzing unit comprises:
a distance analyzing unit for determining statistical distances between the estimated representative expression pattern and the gene network for each of the individuals; and
a model generator for generating a statistical model indicating a distribution of the statistical distances acquired from each of the individuals.

18. The apparatus of claim 17, wherein the distance analyzing unit analyzes a statistical distance between the estimated representative expression pattern and the gene network of the subject.

19. The apparatus of claim 14, further comprising a data transformation unit that transforms the first expression data and the second expression data with respect to the gene expression patterns using an algorithm that reduces or transforms a dimension of the first expression data and the second expression data.

20. The apparatus of claim 14, wherein the determining unit determines the genetic abnormality by testing a statistical significance level corresponding to a point at which a degree of the similarity analyzed for the subject exists in a distribution of degrees of the similarity analyzed for the group of normal people.
